(19) United States
(12) Patent Application Publication
(10) Pub. No.: US 2013/0103599 A1
(43) Pub. Date: Apr. 25, 2013

(54) METHOD AND SYSTEM FOR CERTIFICATION OF A NOTICE WRITTEN ON A SPACE DEDICATED TO THE PROVISION OF OPINIONS

(71) Applicants: Alain Sgrazzutti, Schaeffersheim (FR); Alexis Schotter, Colmar (FR); Franck Bleriot, Nordhouse (FR)

(72) Inventors: Alain Sgrazzutti, Schaeffersheim (FR); Alexis Schotter, Colmar (FR); Franck Bleriot, Nordhouse (FR)

(21) Appl. No.: 13/441,152

(22) Filed: Apr. 6, 2012

Related U.S. Application Data
(60) Provisional application No. 61/472,708, filed on Apr. 7, 2011.

(51) Int. Cl. G06Q 30/00

(52) U.S. Cl. CPC G06Q 30/018
USPC 705/317

(57) ABSTRACT

The subject of the present invention is a method for certifying an opinion relating to a product or service written by an author, user of a terminal, on a server managing a space dedicated to the expression of opinions, the terminal and the server being integrated into a network, characterized in that the method involves a certification system and comprises:
a step for transmission by a communications interface of the system of a request, destined for the identifiable author, for a proof authenticating the purchase or the use of the product or service by the author,
a step for communication of an element for authentication of a purchase or use by the identified author,
a step for analysis of the authentication element by a unit of the system associated with a database,
a step for generation of a certificate,
a step for transmission of the certificate to the server managing the space for expression of opinions,
a step for association of the certificate with the opinion written by the author.

The present invention relates to the field of authentication systems and more particularly to the field of authentication systems for data accessible over a network.

Currently, the Internet network is fully used for the sharing and the exchange of opinions thanks to the dedicated spaces interface. These spaces can, for example, be blogs, Internet forums or again sites designed to group the opinions of web users. This sharing of opinion thus allows anyone, via a general search engine, to find opinions on a particular subject, opinions expressed by other individuals also interested by this subject.

Commercially, this sharing of opinion allows, for example before the purchase of a product or a service, the opinions on this product of buyers or users to be collected and therefore more relevant information to be obtained than only the partial explanations or the directed recommendations that could be provided by a sales or marketing company for this product or service.

However, it could be that the opinions presented on these spaces dedicated to the exchanges of opinions are not justified. Indeed, some of these comments may be used to denigrate, unjustly, certain products or services by individuals who sometimes have never had any contact with this product or service. Similarly, and more usually, some marketing agencies, under cover of a false identifier, write comments and opinions on the Internet sharing sites that are purposely positive with a promotional, commercial and advertizing objective.

Although the moderation of these exchange spaces allows the unjustified opinions to be limited thanks to human intervention, it does not allow the persons who provide comments in good faith on products or services to be differentiated from those that only have a commercial or denigration objective.

The aim of the present invention is to overcome this drawback by providing a system allowing it to be guaranteed that the opinion left by an interested party on an exchange space is an opinion expressed by a person who has been in contact with the product or service for which an opinion is being expressed.

The subject of the invention is thus a method for certification of at least one opinion relating to a product or service written by an identifiable author, user of a terminal, on a server managing a space dedicated to the expression of opinions, the terminal and the server being integrated into a network, characterized in that the method involves a certification system and comprises:
a step for transmission by a communications interface of the system of a request, destined for the identifiable author, for a proof authenticating the purchase or the use of the product or service by the author,
a step for communication of an element for authentication of a purchase or use by the identified author,
a step for analysis of the authentication element by a unit of the system associated with a database,
a step for generation of a certificate,
a step for transmission of the certificate to the server managing the space for expression of opinions,
a step for association of the certificate with the opinion written by the author.

Another subject of the invention is a certification system designed to be integrated into a communications network connecting one or more terminals and servers to one another for the implementation of a certification method according to the invention, characterized in that the system notably comprises:
a unit for receiving an authentication element supplied by the author of at least one opinion relating to a product or service written on a space dedicated to the expression of opinions,
a unit for analysis of the authentication element connected to a database,
a unit for granting a certificate to at least one opinion written by the author on the space dedicated to the expression of opinions, the certificate being strictly associated with the authentication element.

The invention will be better understood thanks to the description hereinafter, which relates to one preferred embodiment, presented by way of non-limiting example and explained with reference to the appended schematic drawings, in which:

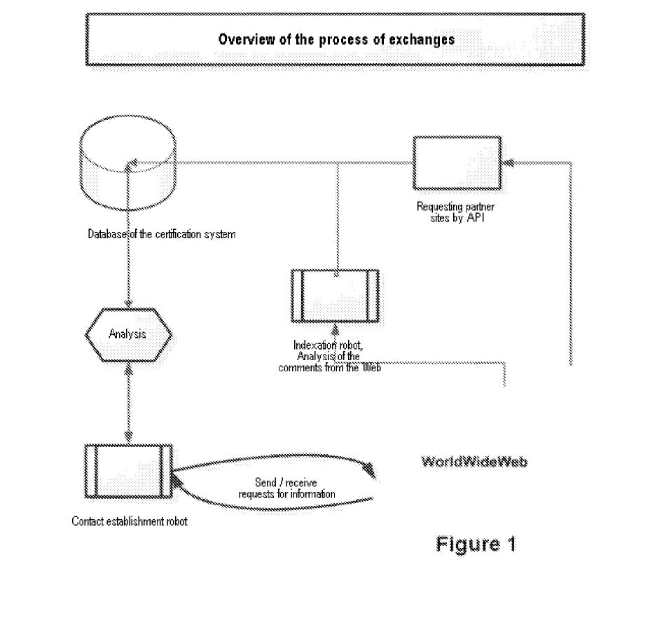

FIG. 1 relates to a schematic representation of an overview of one example of exchanges within the framework of a certification method according to the invention,

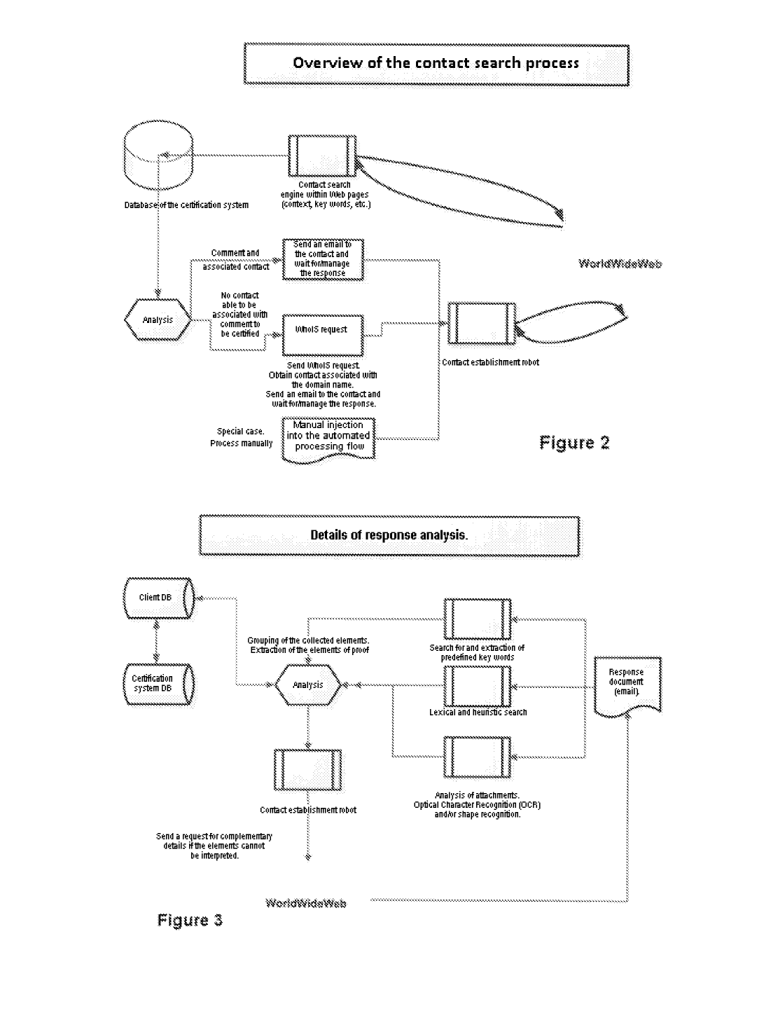

FIG. 2 relates to a schematic representation of an overview of one example of a search for and identification of opinions written on by one or more authors who may be identified in order to be contacted,

FIG. 3 relates to a schematic representation of one example of analysis of an authentication element transmitted by the author of an opinion,

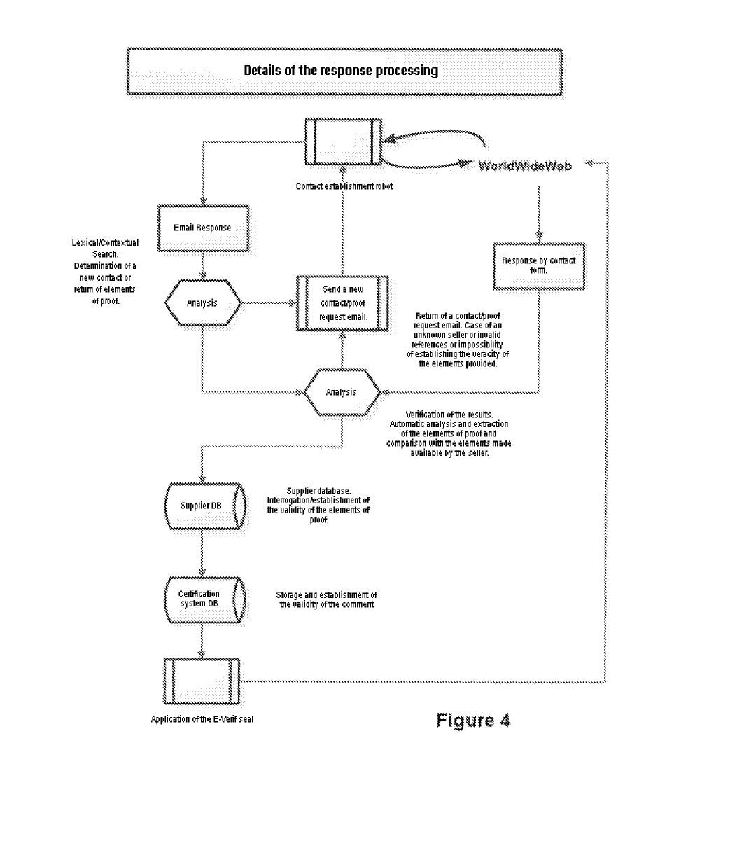

FIG. 4 relates to a schematic representation of one example of implementation of the certification method of the invention.

In the present document, the expression “identifiable author” should be understood as defining an author able to be contacted on the network.

Furthermore, although the network in which the present invention is implemented preferably corresponds to an Internet network, it should be noted that the invention can be implemented in any type of network allowing its operation.

The present invention relates to a method for certifying at least one opinion relating to a product or service written by an identifiable author, user of a terminal, on a server managing a space dedicated to the expression of opinions, the terminal and the server being integrated into a network, characterized in that the method involves a certification system and comprises:
a step for transmission by a communications interface of the system of a request, destined for the identifiable author, for a proof authenticating the purchase or the use of the product or service by the author,
a step for communication of an element for authentication of a purchase or use by the identified author,
a step for analysis of the authentication element by a unit of the system associated with a database,
a step for generation of a certificate,
a step for transmission of the certificate to the server managing the space for expression of opinions,
a step for association of the certificate with the opinion written by the author.

The method according to the invention thus allows the author to certify the comment or the opinion that he/she has written on the subject of a purchase or of a use of a product or service by confirming the purchase or the use of the product or service. This certification then provides credibility for the comment or the opinion written by the author when the latter is read by a third party.

The authentication element consists of an element allowing the purchase or the use of a product or of a service to be justified. In a non-limiting manner, this authentication element corresponds to an identifier or a code present on a till receipt or on a proof of purchase. This authentication element can also be an electronic document or a document requiring an electronic copy of the photography or scan type. Furthermore, this authentication element can also define a level of relevance attributable to the opinion or to the written comment. This level of relevance can be defined depending on the status assigned by the authentication element supplied by the author. The author can thus have, for example, the status of regular user of a product or of a service, the status of one-time user or again the status of owner of a product.

According to a first embodiment, the certification method of the invention comprises at least one step for searching for and for identification of opinions written by one or more identifiable authors on one or more servers connected to the network. This search step is carried out prior to the step for transmission of a request for proof According to one preferred embodiment, this search step is performed by a robot device. For example, this search involves one or more key words allowing the opinions and comments linked with a particular product or service to be located.

These key words are then defined, for example, by a database supplied by the supplier or the producer of the product or of the service for which opinions are sought.

According to one alternative embodiment, this step for transmission of a request is carried out in a manner correlated with the writing of the opinion by the author. This embodiment can be implemented for example when the certification system of the invention is associated with a server managing a space dedicated to the expression of opinions. The step for searching for the author of an opinion or comment is then obsolete since the request for authentication is made during the writing of this opinion or comment.

According to one complementary feature of this alternative embodiment, the step for storing the opinion written by the author in a database of a server is correlated with the communication of an authentication element by the author. Indeed, since the opinion or the comment of the author must be stored in memory on the space dedicated to the expression of opinions, here this operation is correlated with the provision of an authentication element allowing certification of the opinion. It should be noted that, although this is a possibility, the storage of the opinion or of the comment written by an author does not necessarily need to be conditioned to the communication of an authentication element by the author.

According to one non-limiting embodiment of the invention, the step for analysis of the authentication element supplied by the author of an opinion or of a comment involves a step for correlation and for verification of at least one data value of the authentication element with at least one data value of the database associated with the analysis unit of the system. This analysis by correlation thus involves a database comprising at least one type of authentication element for each product or service with which an opinion or a comment is able to be associated. Depending on the type of authentication element, the analysis could be different and carried out on a case by case basis. Indeed, if this authentication element is a simple line of code supplied by the author, the analysis corresponds to the verification of the existence of this line of code in association with a particular product or a service. On the other hand, if this authentication element is a larger electronic document, the analysis may require, or even impose, a search for and a selection of information particular to this document which will need to be correlated with data present in the associated database.

When the authentication element incorporates several data values, the correlation step can then involve a step for weighting each of the verified data values. The weighting is carried out by assigning identical or different values to one or more indices of the authentication element and allows a purchase or a use to be confirmed or otherwise. The cumulation of these indices forms a trunk group which corresponds to an addition of the values characteristic of each index. The sum obtained is then compared with a predetermined value which conditions the step for generation of a certificate.

According to one non-limiting embodiment, this associated database is communicated by the producer or the supplier of the product or of the service for which opinions are sought. Alternatively, the associated database can also be supplied by a sales or comparison interface for these products or services.

In a complementary manner, the method of the invention involves a step for storing, in a dedicated database, a correlation between an analyzed and verified authentication element, a product or a service and an identifier of an author. This storage of the triple correlation authentication/author/product or service thus allows the generation and the provision of a certificate more quickly when an opinion or a comment about a product authenticated by an author already identified is written. This database constructed and supplied by the certification system of the invention can also incorporate an additional step into the certification method, namely a step for verification in the database that the identified author is already associated with a verified authentication for a particular product or a service.

According to one exemplary embodiment of the invention, the implementation of a certification method according to the invention thus involves a certification system designed to be integrated into a communications network connecting one or more terminals and servers to one another, characterized in that the system notably comprises:
a unit for receiving an authentication element supplied by the author of at least one opinion relating to a product or service written on a space dedicated to the expression of opinions,
a unit for analysis of the authentication element connected to a database,
a unit for granting a certificate to at least one opinion written by the author on the space dedicated to the expression of opinions, the certificate being strictly associated with the authentication element.

According to one embodiment of the system of the invention, this certification system is characterized in that it involves an interface for communications with a server managing a space dedicated to the expression of at least one opinion written by an author, identifiable user of a terminal connected to the network, this communications interface forming a part of the certification system and being either independent or integrated into the server managing the space dedicated to the expression of opinions.

According to one alternative to this embodiment, the certification system is characterized in that it involves an interface for communications with a server managing a space dedicated to the expression of at least one opinion written by an author, identifiable user of a terminal connected to the network, this communications interface being managed by a server linked with the product or the service for which an opinion is written, this server forming the interface for all the elements communicated from the author to the certification system.

In addition, as previously explained, in one alternative embodiment, the certification system of the invention is characterized in that it incorporates at least one unit for searching for and identification of opinions written by one or more identifiable authors on one or more servers connected to the network.

One example illustrating a certification method according to the invention for a comment on the blogosphere is detailed hereinafter:
Step 1: Collection of all of the articles, comments and opinions published on the Internet about a company or a brand on the basis of key words defined with it in order to ensure the greatest exhaustivity.

This collection is implemented on all of the possible existing media for expression listed hereinafter:
on-line sales sites,
showcase sites (RSS stream),
specialized search engines: Bing, etc.
platforms of the Apple Store™ type and now on Android™,
blogs internal to companies,
external commercial blogs,
external non-commercial blogs,
personal social networking sites: Facebook™, Linked In™, Myspace™, etc.
professional networking sites: Viadeo™, Ziki™, etc.
micro-blogs: Twitter™, Pownce™, Jaiku™, etc.
video sharing sites: Youtube™, Dailymotion™, Seesmic™, Kyte™, etc.
photo sharing sites: Flickr™, Zoomr™, Smugmug™, etc.
news or rumour sharing sites: Wikipedia™, Wikileaks™, etc.
audio sharing sites: Odeon™,

Just as in the accounts auditing procedures for companies, the exhaustivity of the monitoring procedure is not possible. The idea is, by the definition of the internal procedures for the certification system, to capture the optimal level of comments on the company or the brand by the prior analysis of the key-words chosen for the selection of the articles.

This step is carried out by a software application for collecting opinions and URL addresses of the authors.

This step involves a correlative method: establishment of a management chart of the opinions relating to the company by criterion defined with the company (brand, place, period, etc.). This management chart is made available to the quality, marketing and legal services for analysis and corrective actions within the company.

The collection is carried out in an automated fashion by means of robots which continuously browse the Internet, only retaining the useful comments and information present within the page whose syntax is being analyzed, which are stored for the purposes of verifications, but also by APIs (Application Programming Interfaces) made available to web-hosts wishing to incorporate a proactive verification of their comments.

Plugins are made available to the main Website engines (wordpress, joomla, Magento, etc.) in order to facilitate the integration of the certification solution of the invention for the webmasters.
Step 2: Sending of a predefined request, allowing the fields to be filled in that are needed for the certification and the attachments which will be processed by the certification system of the invention for validating the consumer.

On the basis of the URL addresses of the authors of the opinion, an e-mail is addressed to the author to request from him/her his/her proof of purchase or of ownership of the good or of the service on which he/she is expressing an opinion.

This step may need to be relayed via an intermediary for relaying the message sent by the certification system to the consumer-author; this is for blogs, engines, etc. The message sent to the consumer explains the fundamentals and the role of the certification system, and requests the forwarding of the proof of purchase.

This step allows tools to be made available to the expression means such as blogs, networks, etc., allowing the consumer wishing to give probative force to his/her message to directly incorporate the procedure for transmission of the proof to the certifier. These are tools that, as soon as the article is written, allow the proof of purchase or of ownership to be attached whenever the site generating content in the form of comments makes the choice to incorporate this ethical procedure into its activity.

The identification of the address where an e-mail has to be sent is carried out by means of WHOIS requests, sending an e-mail to generic addresses such as webmaster@domain.com, syntactical analysis of the pages of the site with the purpose of finding a contact form, or an e-mail or postal address allowing the web-host to be contacted. It is the responsibility of the web-host to follow up the request to the consumer-author of the comment.
Step 3: Collection of the responses transmitted by the consumer-author and association with the comment in question.

The proofs are by their nature of many types and will be the object of different recognition and reading processing operations depending on their form. The consumers return the proof of purchase that will enable the comment to be certified by e-mail. The media are of many types and the proofs can take different forms that will need to be processed: invoices, registration documents, till receipt, travel ticket, etc.

By way of example, the invoice is the main proof that the certification system needs to process. It may be received in various data processing formats which will be handled by a document-reading software application.

Furthermore, the e-mail sent to the clients is automatically adapted to the company and/or to the brand in question and will provide information input fields such as the invoice number, place, date, etc.

The validation of the proof is the object of a process allowing a high enough security to be given to the validation of the author as consumer.

It is furthermore understood that, in the framework of this approach and for the first time, all of the players of the “market” for the comments will be systematically informed of the role of the certification system, of the assured and trustworthy approach for the sake of the collectivity and the protection of the consumer and above all of the legal framework and of the risks run with the establishment of false documents, with trying to pass for a false consumer, etc.

A dedicated Internet page is set up for receiving the responses to the automated requests, allowing the user to provide elements that prove his/her status as a consumer in the case of the collection by robot.

In the case of a proactive verification, freedom is given to the web-host to use the APIs made available for the correct verification of his/her data.

The documents are recognized by the implementation of text recognition technologies and of several text and graphical search algorithms implementing statistical methods in order to identify the probative elements in documents of various forms and origins and by manual statistical tests.

With regard to the invoices, tools for association of the information contained in the invoices with the invoicing files of the companies have been developed and allow the information obtained to be cross-checked by means of APIs supplied by the companies wishing to participate in that certification system.

If the companies do not wish to grant access to their data processing systems, they are solicited to extract the required data in the form of files which must then be certified by their auditors by means of the sending of automated messages to an address defined by the company, where the method can just as easily be a WEB POST/GET request or an e-mail, or even an automated posting of letters by mail.

The certification system incorporates a system for storing the proofs, for reading and for validation: the combination with the data of the company constitutes an additional validation procedure, but the reception of the original document is itself sufficient. At any given time, a garnishee (bailiff, statutory inspector, etc.) may come and verify the existence of the proof and the reality of the certified consumer.

The consumer does not have to prove his/her identity but simply his/her act of purchase, thus the certification procedure is constructed at each step in order to respect and promote the freedom of expression over the internet in as much as the whole approach of the players concerned is to ethical standards and guarantees the web user access to information not made up of fictitious comments, favorable comments generated by marketing agencies, of denigrating false comments constituting negative actions toward a brand or a company.
Step 4: The certification of the comment on the web.

The grouping of the verified and certified comments/consumers is assigned a logo indicating the certification of the comment and informing the reader of the reality of the consumer author of the comment.

The logo is applied in the form of an image containing a link to a page on the servers of the certification system which re-states the comment in question and its date of verification. The technique for assigning the logo depends on the media on which the comment is present.

The tools and modules of the certification system available to blogs, engines, networks for posting the comments have been developed and made available to the web-hosts.

The logo or stamp is active and allows the reader to access the certification system site, which site provides information on the role of the certifier, his/her charter, the charter adhered to by his/her clients, the legislation, the clients of the certification system, actor for probity on the WEB, the partners of the certification system, blogs, companies for marketing provision services on the web, etc.

The logo also allows access to the right of response of the company on the comment in question by the company concerned.

The presence of the logo when a request is made by the web user on the brand in question allows him/her to be made aware of the content of the comment while knowing that the author is indeed a consumer of the product or the service.

In a correlative manner, a filter tool that may be downloaded or provided by the players, engines, networks, etc. wishing to be part of the approach for probity on the WEB and for protection of the consumer, while at the same time promoting the development of the expression of the consumers in the interests of competition and ethics allows the web user to only have access to certified comments.
Step 5: Establishment of a database of certified comments available to the auditing bodies and the directors of client companies.

The information relating to the procedures for establishment of the proof are never communicated to third parties, not even to the company or to its advisors, in order to preserve the anonymity of the consumer (URL address, copy of the proof, etc.), this information being stored in an encrypted form in an intermediate database, different from the database of the certified comments, which itself only contains the text of said comment and a unique identifier allowing the correlation with the intermediate database.
Step 6: make the certified information and comments available to the web users either by means of a specific search engine only presenting the comments or the approved sites of the certification system or by means of engines offering their user access to the filter tools aiding the request for certified comments.

A search engine for the certified comments will be made available to the users allowing them to display all of the comments by key words.

Alternatively, in a complementary manner, one example illustrating a certification method according to the invention for a comment on commercial sites, trading or non-trading, is detailed hereinafter:

The certification of the comments forms part of an overall approach to probity of the players of the WEB. The stakeholders are the company or the brand wishing to contribute to honesty on the WEB, complying with the postulate that 70 to 80% of consumers trust the opinions of their peers when buying or consuming on the net.

The company possessing a commercial site displaying comments, or making use of external service providers to manage this function, is obliged to set up the procedure for certification of the consumer in order to obtain the permanent quality certification.

The method implemented is similar and also requires, from the certification system of the invention, the provision of the proof of the consumer status.
STEP 1: Collection of the comments placed on the site of the company or with its external service provider associated, on the one hand, with the establishment of an immediate redirection onto the servers of the system for certification of the comments and URL addresses of the author of the comment who has identified himself on the company site, and on the other hand, with the installation of a direct certification procedure available to the client/consumer when the comment is posted, but also with the establishment of a certification procedure with the external service provider by an electronic processing method for transfer of the comments and for collection of the proof.

Furthermore, in a manner correlated with the electronic data processing, a permanent auditing procedure for the tools and charters applicable for obtaining the overall certification of the information displayed on the site is implemented by teams for the certification system in the framework of a contractual relationship and engaging the company or the brand in its ethical and transparent approach with regard to the use of the comments on its site.

The system makes tools available to the company promoting the transparency and the action of the certification system, with notably information from the certification system on the site and a code or number sequence application on the invoice, which are confidential and allow the identification of the consumer when his/her comment is published on the site or elsewhere on the blogosphere.

The certification system is never directly a collector or generator of comments.

The certification system is a certifier preserving the freedom of action of the consumer and does not intervene in the marketing policy of the company, but contributes to the definition of the latter by its services or its service providers by forcing certification system compliance with the approved ethical charter of the company.

Several methods may be used for the recovery of the comments:

The certification system may offer to the trading and non-trading sites to manage for them the comments on their products, either by the use of iframes on their site or by a WEB redirection onto the servers of the certification system for the writing/display of comments, or alternatively, by javascript codes made available to trading and non-trading sites.

The certification system can provide APIs allowing webmasters to incorporate the tools of the certification system directly into their site (provision of a proof of purchase when writing the comment, contact email allowing the proof of purchase to be supplied later on, automatic forwarding of the comment and of a means of contact of the author on the servers of the certification system).
STEP 2: Sending an e-mail and a request to the consumer in order to obtain the proof of purchase and storage of the comment for association with the opinion published on the sites or with the external service providers so as to ensure the publication of the entirety of the comment.

The consumer that wishes to see his/her comment certified returns the elements of proof needed for the certification of his/her comment.

This step is only necessary for a retrospective verification. This is because the certification system also allows the comment to be verified when it is written, the consumer having the possibility of sending proof of his/her good faith directly from the comment writing form.
STEP 3: Establishment of a folder for the certified comments available for publication for the company or its service provider.

The database of certified comments for a particular site is made available by means of available APIs, made secure by passwords, coupons, or any other encryption means and access control means. JavaScript modules and codes may be provided in order to facilitate the integration work for the trading or non-trading sites.

### 1) Recovery of Comments Present on the Internet:

In order to recover the comments present on the internet, the certification system uses robots similar to the existing indexation robots of the search engines, whose function is to index all the sites on which comments have been found, together with the means for contacting the administrators of said sites so as to contact them and to offer them the integration of the certification solution of the invention. Several text search algorithms will be used in combination with statistical methods to search for the presence of key words or cross-checking over the key-words used. Specialized search engines may also be used.

### 2) Contact of the Sites Downloaded by the Indexation Robots:

An email is sent for contacting the sites containing comments to be verified, offering them the tools of the certification system for a faster verification of the comments. When the contact with the consumer/author is not possible, an email is also sent to the webmaster of the site in question with a request to follow up the verification request to the consumer/author.

### 3) Recovery of the Proofs:

The email sent to the consumer/author contains a link to a page on the servers of the certification system where the consumer, when he/she wishes to get his/her comment verified, can upload various elements allowing his/her comment to be validated: date of purchase and email used for this purchase, invoice number, scan of the invoice for the product/service, date/time and purchase price, etc.

### 4) Cross-Checks and Validation of the Proof:

The elements sent by the consumer are cross-checked with the seller company of the product or service on which the comment has been posted by means of automated requests. Any element allowing the consumer to be identified is removed in order to prevent any attempt to identify the consumer by the seller company. The techniques used for validating the proof are optical character recognition (OCR), cross-checking with information supplied by the seller companies via automated or otherwise exchanges of data, or by accessing a part of the databases of the seller companies.

Regarding the verification of the proofs, this is carried out by successively:
recovering the elements of proof via a form on an Internet page, or by reply to an e-mail on a post-box which is read by a software application designed to fill out the form based on the content of the e-mail. The elements recovered are, for example, the scan of an invoice or date and time of purchase or customer account number, or total amount of purchase or email address used for the purchase, or invoice number, or reference of the product purchased,
processing the elements by: character or image recognition (bar codes for example), syntactical analysis, text search for key words, grammatical analysis of the texts in order to extract the elements of interest from these,
assigning a score to each element from the preceding point in order to supply a final score used to validate the proof or proofs,
associating the data with the data of the seller company: by the automated sending of an e-mail, the reply to which is processed automatically in the same manner as for the proofs; automatically associating with databases made available by the client companies having carried out the procedure for opening all or part of their databases with the certification system.
identifying the comment as “verified and valid” or “verified and not valid”.

Regarding the link with the “commentator” sites:
the certification system of the invention provides: modules for the main blog engines and CMS (Content Management System), for example wordpress or joomla, which will make the link with the certification system (a simple connector with the API of the certification system),
API of the certification system: for the webmasters wishing to develop their site themselves, the certification system can provide simple methods amongst which are notably:
   a method allowing a comment to be submitted for validation (it is the responsibility of the webmaster to present the commentator with a form requesting the proof, or to supply a contact email address for the commentator),
   a method allowing the status of a comment to be known according to its identifier,
   a method allowing either JavaScript code to be returned, which will display the link and the image of the certification system stamp, or the image and the link to the certification system stamp to be directly returned.
a unique identifier is assigned to each comment by site, and this identifier appears in the database of the certification system, used as a link between the comments of said site.

The image of the stamp “verified” is in fact a link or JavaScript code which will verify each time the page is loaded onto the servers of the certification system the status of the comment. Depending on the result, the image changes, and if the user clicks on this image, he/she is taken onto the site of the certification system, at the page relating to the comment on which he/she has clicked.

It goes without saying that the invention is not limited to the embodiment described and shown in the appended drawings. Modifications remain possible, notably from the point of view of the composition of the various elements or by substitution of equivalent techniques, without however straying from the scope of protection of the invention.

What is claimed is:

1. A method for certification of at least one opinion relating to a product or service written by an identifiable author, a user of a terminal, on a server managing a space dedicated to the expression of opinions, the terminal and the server being integrated into a network having a certification system, the method comprising:
transmitting by a communications interface of the certification system a request, destined for the identifiable author, for a proof authenticating the purchase or the use of the product or the service by the identifiable author;
communicating an authentication element of the purchase or the use by the identifiable author;
analyzing the authentication element by the certification system associated with a database;
generating a certificate;
transmitting the certificate to the server managing the space for expression of opinions; and
associating the certificate with the opinion written by the identifiable author.

2. The method according to claim 1, further comprising:
searching for identification of opinions written by one or more identifiable authors on one or more servers connected to the network before transmitting by the communications interface of the certification system the request.

3. The method according to claim 1,
wherein transmitting by the communications interface of the certification system the request is carried out in a manner correlated with of the opinion written by the identifiable author.

4. The method according to claim 3, further comprising:
storing the opinion written by the identifiable author in a database of the server,
wherein storing the opinion is correlated with the communication of the authentication element by the identifiable author.

5. The method according to claim 1, wherein analyzing the authentication element includes correlating and verifying at least one data value of the authentication element with at least one data value of the database associated with an analyzer of the certification system.

6. The method according to claim 5, wherein, the authentication element incorporating several data values, correlating at least one data value of the authentication element includes weighting each of the data values verified with a data value from the database and generating the certificate is conditioned by comparing each weighted data value with a predetermined value.

7. The method according to claim 1, further comprising:
storing, in a dedicated database, a correlation among an analyzed and verified authentication element, the product or the service, and an identifier of the identifiable author.

8. A certification system designed to be integrated into a communications network connecting one or more terminals and servers to one another for certifying at least one opinion relating to a product or service written by an identifiable author, a user of a terminal, on a server managing a space dedicated to the expression of opinions, the certification system comprising:
receiver configured to receive an authentication element supplied by the identifiable author of the at least one opinion relating to the product or the service written on a space dedicated to the expression of opinions;
an analyzer configured to analyze the authentication element connected to a database; and
a certifier configured to grant a certificate to the at least one opinion written by the identifiable author on the space dedicated to the expression of opinions, the certificate being strictly associated with the authentication element.

9. The certification system according to claim 8, further comprising:
a communications interface configured to communicate with the server managing the space dedicated to the expression of the at least one opinion written by the identifiable author, an identifiable user of the terminal connected to the network, the communications interface being either independent or integrated into the server managing the space dedicated to the expression of opinions.

10. The certification system according to claim 9, wherein the communications interface is managed by a server linked with the product or the service for which an opinion is written and the server forms the communications interface for all elements communicated from the identifiable author to the certification system.

11. The certification system according to claims 8 further comprising:
a searcher configured to search an identification of opinions written by one or more identifiable authors on one or more servers connected to the network.

12. The method according to claim 4, wherein storing the opinion is correlated with the communication of the authentication element by the identifiable author.
